(19) United States
(12) Patent Application Publication
(10) Pub. No.: US 2022/0350731 A1
(43) Pub. Date: Nov. 3, 2022

(54) METHOD AND SYSTEM FOR TEST AUTOMATION OF A SOFTWARE SYSTEM INCLUDING MULTIPLE SOFTWARE SERVICES

(71) Applicant: RIA Advisory LLC, Coral Gables, FL (US)

(72) Inventors: Choon Hoong Ding, Melaka (MY); Supriya Mukhapadhyay, Naperville, IL (US); Saket Pabby, Coral Gables, FL (US)

(73) Assignee: RIA Advisory LLC, Coral Gables, FL (US)

(21) Appl. No.: 17/244,417

(22) Filed: Apr. 29, 2021

(51) Int. Cl. G06F 11/36

(52) U.S. Cl. CPC G06F 11/3688; G06F 11/3684

(57) ABSTRACT

A mechanism is provided to perform test automation of software systems operating in a variety of modes. Embodiments enable formation of test scenarios having a set of successive steps that can be executed by selected services in the software system environment under test. Data from each step can be provided to a next step by step chaining. Step chaining data can be provided by, for example, entire json objects or the like, thereby normalizing expected input data for the steps. Embodiments further enable formation of project features that have a set of successive test scenarios. Data from each test scenario can be provided to a next test scenario by scenario chaining. Again, scenario chaining data is provided in a normalized fashion. By enabling the passage of data between test scenario steps and feature test scenarios, end-to-end automated testing can be performed in a mode agnostic fashion.

### BACKGROUND

### Field

This disclosure relates generally to information handling systems, and more specifically, to a mechanism for test automation of a software system that enables end-to-end testing of a variety of services having differing modes of operation.

### Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The differences between information handling systems, and the differences of uses for the systems and the data therein, result in a wide variety of data formats and mechanisms to access that data. In many business environments, multiple types of information handling systems are used together to perform complex tasks relying on services executing on the information handling systems. Ensuring that these multiple services can work together to provide reliable and consistent results can be a challenging task. Testing the services executed by the information handling systems, including a variety of software systems operating in multiple modes, is a way to ensure this reliability is achieved.

Test automation is a testing technique for software-systems executed by information handling systems that executes test case suites using automated testing tools. Automated testing, as compared with manual testing, can allow time and resources to be freed in the development and testing process, with testing performed at higher speed and with higher accuracy and lower cost. Such testing can include functional and load or stress testing. Automated tests provide consistent results and data points. Among the benefits of test automation are release of good quality code, ease of maintenance, reduction in manual labor and time needed to complete regression testing, ability to efficiently use resources in off-peak hours, and the capability to create reports based on the executed tests.

### BRIEF DESCRIPTION OF THE DRAWINGS

Embodiments of the present invention may be better understood by referencing the accompanying drawings.

FIG. 1 is a generalized illustration of an information handling system 100 that can be used to implement the test automation system and method of the present invention.

FIGS. 2A and 2B are a simplified block diagram illustrating relationships between test steps, scenarios, features, and projects in accord with embodiments of the present invention.

FIG. 3 is a simplified flow diagram illustrating an example of the steps performed in creating and executing an end-to-end test in accordance with embodiments of the present invention.

FIG. 4 is a simplified block diagram illustrating an example of step linking between steps within a test scenario 405, in accordance with an embodiment of the present invention.

The use of the same reference symbols in different drawings indicates identical items unless otherwise noted. The figures are not necessarily drawn to scale.

### DETAILED DESCRIPTION

Embodiments of the present invention provide a mechanism to perform test automation of software systems operating in a variety of modes (e.g., user interface, API, and batch). Embodiments enable formation of test scenarios having a set of successive steps that can be executed by selected services in the software system environment under test. Data from each step can be provided to a next step by step chaining. Step chaining data can be provided by, for example, entire json objects or the like, thereby normalizing expected input data for the steps. Embodiments further enable formation of project features that have a set of successive test scenarios. Data from each test scenario can be provided to a next test scenario by scenario chaining. Again, scenario chaining data is provided in a normalized fashion. By enabling the passage of data between test scenario steps and feature test scenarios, end-to-end automated testing can be performed in a mode agnostic fashion.

In software system testing, test automation includes using a system separate from the software system being tested to control execution of tests and comparison of actual outcomes with predicted outcomes. Test automation is intended, in part, to automate some repetitive but necessary tasks in a formalized testing process or perform additional testing that would be difficult to do manually. Using a test automation tool, a test suite can be recorded and replayed as needed. This reduces the number of test cases needed to be executed manually and thereby reduces human intervention in the testing process. Test automation can be an important part of continuous delivery and continuous testing.

A testing pyramid provides an overview of different levels of testing—from small units to an overall connected process. Level 1 is at the base of the pyramid, while levels 2 and 3 are at the higher levels of the pyramid. Level 1 testing (or unit testing) involves testing individual units of code or groups of code units in a piece of software. Unit testing is performed using known internal workings and implementation details of the code being tested, and fashioning test code that is closely tied to those known internals. Level 1 testing is largely performed by code developers. Level 2 testing (or integration testing) involves testing how units of code interact with one another. This can involve testing a chain of code components, including some external components, that together handle a process or a business transaction. Integration testing can include testing interactions between hardware and software, or interactions with other infrastructure components.

Level 3 testing (or end-to-end testing) involves testing a process from end to end. Scope of end-to-end testing depends on the processes being tested but can span multiple technologies and modes of operation. A purpose of end-to-end testing is to ensure that a flow works as intended from the perspective of a user. End-to-end testing can be performed without knowledge of the internal workings or implementation of the software system being tested, wherein only the inputs and the expected outputs are known.

Specific testing methodologies can be incorporated in the various levels of testing, depending upon the nature of the software system under test and the environment in which the system is executing. These testing methodologies can include, for example, functional testing, regression testing, exploratory testing, load testing, performance testing, penetration testing, usability testing, user acceptance testing, user interface testing, and API testing. All these types of testing add differing value to the software verification and delivery process.

Some embodiments of the present invention are intended for use in end-to-end regression testing of a software system. Such testing determines whether a change or addition made to an existing software application does or does not disrupt any existing functionality of the software application. By re-running testing scenarios that were originally scripted when known problems were first fixed, one can ensure that any new changes to the application have not resulted in a regression or caused components that formerly worked to fail.

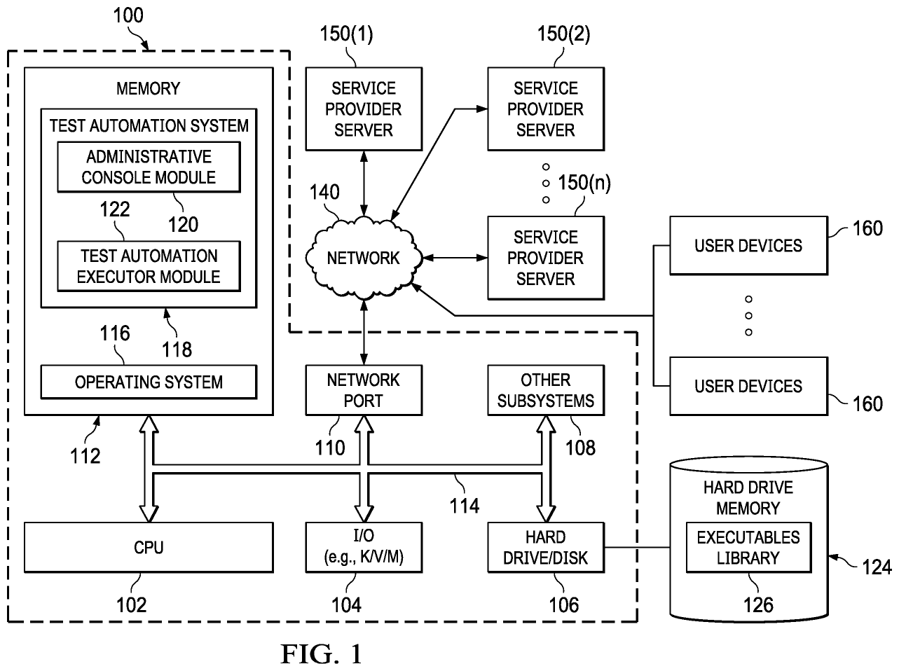

FIG. 1 is a generalized illustration of an information handling system 100 that can be used to implement the test automation system and method of the present invention. Information handling system 100 includes a processor (e.g., central processor unit or “CPU”) 102, input/output (I/O) devices 104 (e.g., a display, a keyboard, a mouse, and associated controllers), a hard drive or disk storage controller 106, and various other subsystems 108. In various embodiments, information handling system 100 also includes network port 110 operable to connect to a network 140, which is likewise accessible by one or more service provider servers 150(1)-(N) and set of user devices 160. Information handling system 100 likewise includes a system memory 112, which is interconnected to the foregoing via one or more buses 114. System memory 112 further comprises an operating system (OS) 116 and in various embodiments may also comprise test automation system module 118.

Test automation system module 118 performs operations associated with testing of a software system environment utilizing resources, accessing information from, or providing information to one or more service providers (e.g., service provider servers 150(1)-(N)). Test automation system module 118 includes an administration console module 120 and a test automation executor module 122. Administration console module 120 is configured to capture and maintain information associated with the systems under test, including, for example, identification of one or more external systems (e.g., service provider servers) or environments (e.g., development, test, and pre-production), identification and nature of test services from each external system (e.g., API, batch, or UI), and the test step definitions. Executables that can provide such information can be stored in an executables library 126 stored in a hard drive memory 124 controlled by hard drive/disk storage controller 106. Test automation executor module 122 is configured to access information from one or more of the service provider servers using appropriate commands for such access (e.g., using a test application stored in executables library 126 that can capture features, test scenarios, test steps, test data, and the like, as will be discussed in greater detail below) and then providing the accessed data to one or more other service provider servers for subsequent test tasks in a format and location expected for the operations of those service provider servers. Test automation executor module 122 can also execute test scenarios that will be discussed in greater detail below.

As will be appreciated, once the information handling system 100 is configured to perform test automation operations, the information handling system 100 becomes a specialized computing device specifically configured to run test scenarios and is not a general-purpose computing device. Moreover, the implementation of the test automation operations on the information handling system 100 provides a useful and concrete result of testing and validating a system under test by the test automation operations.

Embodiments of the test automation system are configured to perform end-to-end testing of a software system that relies on a variety of service provider servers for one or more of information, processing, storage, or other data manipulation. The service provider servers can operate in a variety of operational modes, such as, for example, user interface, batch processing, and API. Operations performed by these various services can be coupled in a set of steps by a software system to perform a desired operation by a subscriber to these services. The variety of operational modes and the variety of expected inputs and outputs from the services make it difficult for traditional testing systems to perform end-to-end tests. Typically, traditional testing systems focus on one mode of operation for their tests, and therefore cannot perform an automated end-to-end test.

As will be discussed in greater detail below, embodiments enable a user to configure various test scenarios and their corresponding steps to set up an end-to-end test. Scenarios can be grouped as features for ease of maintenance and test execution. Once the features are set up, embodiments can be integrated into a continuous integration/continuous development (CICD) process to automatically execute the test suite when a new deployment is performed. Embodiments can also generate reports to illustrate test results.

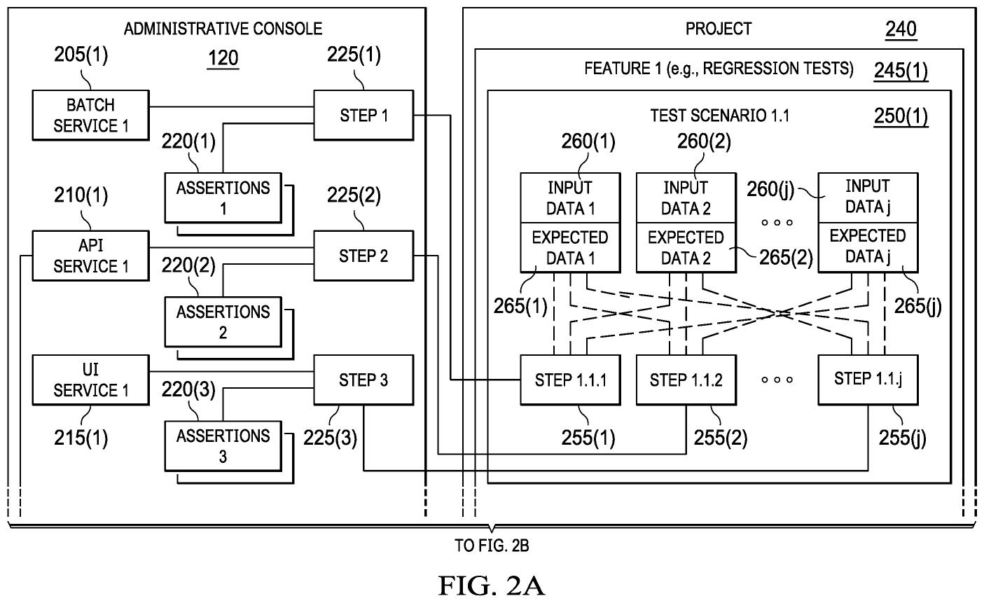

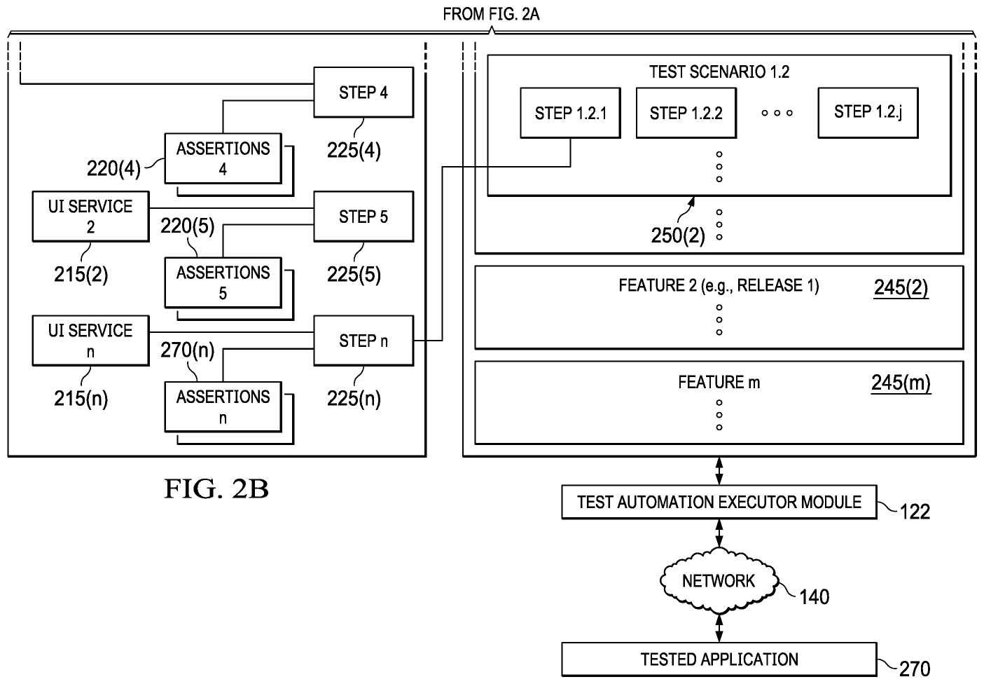

FIGS. 2A and 2B are a simplified block diagram illustrating relationships between test steps, scenarios, features, and projects in accord with embodiments of the present invention. As discussed above, embodiments are configured to test a software environment that incorporates a variety of services executed by service provider servers (e.g., 150(1)-(N)). Such services can take the form, for example, of batch services (e.g. batch service 1 (205(1))), API services (e.g., API service 1 210(1))), and user interface services (e.g., UI service 1 (215(1)), UI service 2 (215(2)), and UI service n (215(n))). Each of these services, along with a corresponding set of assertions 220(1)-(n), are associated with a corresponding test step 225(1)-(n).

As illustrated in FIGS. 2A and 2B, configuration of the services contributing to the test steps, the associated assertions, and the nature of the test steps is performed using administrative console 120. Certain preconfigured tests can be provided by embodiments for commonly-used services (for example, Oracle's Revenue Management and Billing system or E-Business Suite). One or more standard assertions 220 can be preconfigured with embodiments. An intuitive user interface can be provided by embodiments to enable selection of assertion values from input test data and response payload. Alternatively, custom assertions can be created by a user of the system. In certain embodiments, custom assertions can be created using SQL statements and, in other embodiments, custom assertions can be created using formulas and scripts. Assertions can be configured at administrative console 120 to be performed at various points in the execution of a series of steps. For example, assertions can be performed prior to execution of a scenario that includes a series of steps, prior to execution of a specified step, subsequent to execution of a specified step, or after execution of the series of steps. In addition, each assertion can include an indicator that allows a user to specify whether test execution should terminate in the event of a validation failure.

FIGS. 2A and 2B further illustrates how the tests can be configured for the various services. These configurations can be set up by a user or preconfigured, as determined by the business scenario. A project 240 can be created to encompass all the various feature testing desired for the software system. The project can include one or more features (e.g., 245(1)-(m). These features provide an opportunity to group a set of one or more test scenarios (e.g., 250(1)-(2)), where each test scenario includes one or more steps (e.g., 255(1)-(j)). These steps are the same as those discussed above with regard to the administrative console, but with configured test input data (e.g., 260(1)-(j)) and expected data (e.g., 265(1)-(j)) used to test the assertions associated with each step.

As discussed above, each step within a scenario can invoke a service (e.g., 205, 210, or 215), each of which can be configured to invoke a batch job, an API, or a user interface page, for instance. Embodiments enable each step within a test scenario to exchange data with other steps within the scenario through step chaining. Embodiments perform step chaining by allowing passage of json (JavaScript Object Notation) objects between steps in the test scenario. Passage of json objects allows for more than one field at a time being provided between steps, which reduces programming overhead. In addition, embodiments can provide a common json object to pass information between each step. In this manner, data passage becomes agnostic to the mode of operation of the service (e.g., batch, API, or UI). In addition to step chaining, as discussed above, embodiments can pass json objects between test scenarios, thereby enabling longer, more sophisticated testing of how various software systems interact. Once the various steps/test scenarios are linked together in this manner, a full end-to-end regression test can be performed on the software system incorporating all the tested services.

Once a project 240 is configured, the project can be passed from the administrative console (e.g., 120) to a test automation executor module (e.g., 122) for implementation of the project. During execution, the test automation executor can provide input test data to a tested application 270, which can be executing on an information handling system (e.g., service provider server 150(1)-(N)) accessible to the test automation executor via a network 140, and the test automation executor will verify that the actual data from a response payload matches the configured expected data (e.g., assertions).

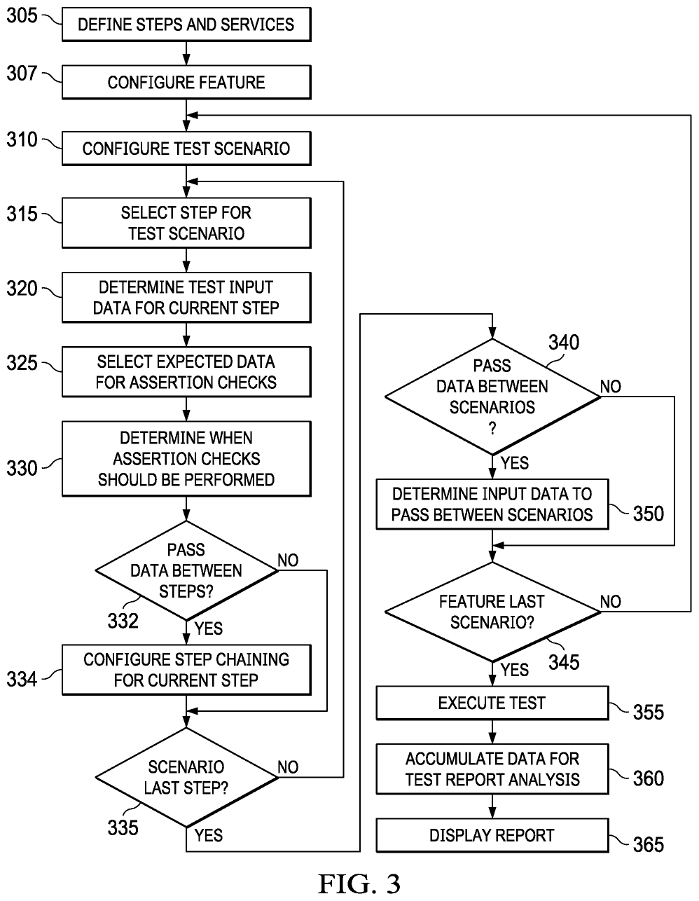

FIG. 3 is a simplified flow diagram illustrating an example of a process performed in creating and executing an end-to-end test in accordance with embodiments of the present invention. Initially, the external systems are identified (e.g., service providers and environments are identified), software services being incorporated in the test are defined, and the steps used in the end-to-end test are defined (305). This setup can include defining what portions of the software service are being tested and the assertions to run against the data generated by the software service (e.g., selecting predefined assertions or generating a SQL or formula-based assertion).

A feature incorporating a set of test scenarios can be configured to incorporate the desired test scenarios (307). A test scenario incorporated in the feature can then be configured to lay out the steps that will be performed (310). A step from those defined above in relation to the software services is selected for the test scenario (315). Test input data for the step is then determined (320). Test input data can be either data that is generated, for example, by a previously executed step or data which is input through a user interface or system generated. In addition, data including the expected results are selected for checking the assertions (325). The assertion check data can include pointers to where the information can be found within various data sets that can be subjected to an assertion formula or a predetermined assertion incorporated with the tool. In addition to selecting the assertion check data, a determination can be made as to when the assertion checks should be performed by the tool (330). As discussed above, the assertion checks can be executed at various times, including before or after the execution of a step, or before or after execution of a test scenario. A determination is made as to whether data should be passed between steps (e.g., step chaining) (332). If step chaining is desired, then step chaining is configured for the current step (334). At this point, data objects for passage of data between the current step and other steps can be defined.

If the step being configured is not the last step for the scenario (335), then another step is selected and configured (315-334). If the step is the last step for the scenario, then a determination is made as to whether data should be passed between scenarios (340). If so, then a determination is made as to which data is passed between scenarios (350). Then a query is made as to whether the scenario being configured is the last scenario of a feature (345), and if not, then a next test scenario is configured (310).

Once the end-to-end test project is configured, the test can be executed (355). Test execution is performed by the test automation executor 122, which communicates with the various service provide servers 150 to execute the test applications 270. During the course of the testing, the data from the assertions is accumulated for test report analysis (360). Once the test report is completed, the report can be displayed (365). Based upon the information in the report, modifications to the various software services and the data used for those services can be made to correct any errors seen in the assertion report.

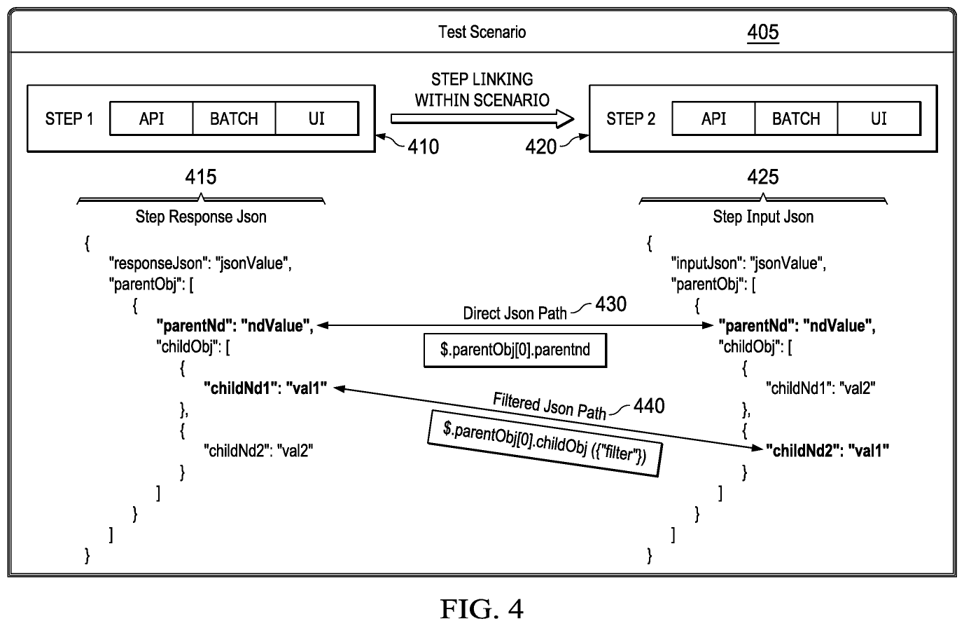

FIG. 4 is a simplified block diagram illustrating an example of step linking between steps within a test scenario 405, in accordance with an embodiment of the present invention. As illustrated, a first step 410 is linked with a second step 420. As discussed above, such a linkage is performed by configuring passage of information from the first step to the second step through passing of a json field or object. First step 410 can function in one of an API, batch, or user interface mode. Second step 420 can also function in one of an API, batch, or user interface mode, and that mode does not need to be the same as that of the first step.

At least some of the output from the first step can take the form of step response json object 415. json object 415 can include, for example, a parent object (e.g., parentNd) that has one or more child objects (e.g., childNd1 and childNd2). Similarly, at least some of the input to the second step can take the form of a step input json object 425. json object 425 can include a parent object (e.g., parentNd) that has one or more child objects (e.g., childNd1 and childNd2). Paths from key values within json object 415 to json object 425 can be defined during the configuration phase of testing (e.g., step 320 from FIG. 3). For example, a direct path 430 can be defined between the parent object of json 415 and the parent object of json 425. As another example, a filtered json path 440 can be defined between one of the child objects of json object 415 (e.g., childNd1 of json object 415) and a child object of json object 425 (e.g., childNd2 of json object 425). In this manner, flexibility is provided in structuring the passage of data between steps within a test scenario. As illustrated in FIG. 2, input data can be provided from more than one step to a subsequent step in a scenario, and a step can provide output data to more than one subsequent step in a scenario. In a similar fashion, json objects can be used to pass information from one or more test scenarios to subsequent test scenarios.

The information handling system provided by embodiments of the present invention enable performance of test automation of a software system environment that include services operating in a variety of modes. This is accomplished, in part, by providing a way to pass data in mode agnostic manner between the various services. Embodiments can provide this by using json objects and group and field level data within such objects. Embodiments enable an end-to-end test of the software system environment, rather than only testing portions having common modes, thereby providing a more efficient and accurate mechanism by which to test the software system.

By now it should be appreciated that there has been provided a method for automating test of a software system that includes a plurality of software services. The method includes defining a plurality of test steps where each test step includes one or more actions executed by a software service of the plurality of software services, configuring a first test scenario at an information handling system executing an administrative console module of a test automation system, and executing the first test scenario at a test automation executor of the information handling system. The first test scenario includes one or more test steps of the plurality of test steps. A first subset of the one or more test steps are chained to one another by passing output data from a first test step of the first subset as input data to a second test step of the first subset. The output data of the first test step is a first JavaScript object notation (json) object. The input data of the second test step is a second json object. The chaining passes group and field-level data from the first json object to the second json object.

In one aspect of the above embodiment, the method further includes collecting assertion information associated with each of the one or more steps of the first test scenario, and displaying a report including information associated with the assertion information. In another aspect, configuring the first test scenario includes selecting a test step of the plurality of test steps, determining input data for the test step where the input data includes one or more of user interface data, data output from a previous test step, and data provided from a data store, selecting output data from the test step for an assertion check, selecting a data source for comparison in the assertion check, and determining when an assertion check is performed. In a further aspect, determining when an assertion check is performed includes selecting whether the assertion check is performed prior to execution of the test step, subsequent to execution of the test step, or during execution of the test step.

In another aspect of the above embodiment, the method further includes configuring a second test scenario at the information handling system executing the ministry of console module test automation system. The second test scenario includes one or more steps of the plurality of test steps. A second subset of the one or more test steps are chained to one another by passing output data from the first test step of the second subset as input data to a second test step of the second subset. The output data of the first test step of the second subset is a third json object and the input data of the second test step of the second subset is a fourth json object. The chaining passes group and field level data from the third json object to the fourth json object. In a further aspect, the method includes configuring a feature including the first test scenario and the second test scenario, and chaining the first test scenario to the second test scenario by passing output data from the first test scenario as input data to the second test scenario. The output data from the first test scenario includes output data from one or more test steps of the first subset. The input data to the second test scenario includes input data to one or more test steps of the second subset.

In another aspect of the above embodiment, the plurality of software services include one or more of batch services, application program interface services, and user interface services. In a further aspect, executing the first test scenario includes an end-to-end test of the software system.

Another embodiment provides an information handling system configured to automate a test of a software system including a plurality of software services. The information handling system includes a processor configured to execute a set of instructions for automating the test of the software system, a network interface, coupled to the processor and to a network, and a non-transitory, computer-readable storage medium coupled to the processor. The network interface is configured to communicate with one or more service provider servers coupled to the network where each of the one or more service provider servers provides one or more corresponding software services of the plurality of software services. The non-transitory, computer-readable storage medium stores the set of instructions executable by the processor. The instructions are configured to cause the processor to define a plurality of test steps where each test step includes one or more actions executed by a software service of the plurality of software services, configure a first test scenario, by an administrative console module of the test automation system, and execute the first test scenario at a test automation executor of the information handling system. The first test scenario includes one or more test steps of the plurality of test steps. A first subset of the one or more test steps are chained to one another by passing output data from a first test step of the first subset as input data to a second test step of the first subset. The output data of the first test step is a first json object and the input data of the second test step is a second json object. The chaining passes group and field level data from the first json object to the second json object.

In one aspect of the above embodiment, the set of instructions are further configured to cause the processor to collect assertion information associated with each of the one or more steps of the first test scenario, and display a report including information associated with the assertion information.

In another aspect of the above embodiment, the instructions to configure the first test scenario include instructions further configured to cause the processor to determine input data for the test step where the input data includes one or more of user interface data, data output from a previous test step, and the data provided from a data store, select output data from the test step for an assertion check, select a data source for comparison in the assertion check, and determine when an assertion check is performed. In a further aspect, the instructions to determine when an assertion check is performed include instructions further configured to cause the processor to select whether the assertion check is performed prior to execution of the test step, subsequent to execution of the test step, or during execution of the test step.

In another aspect of the above embodiment, the set of instructions are further configured to cause the processor to configure a second test scenario at the administrative console module of the test automation system. The second test scenario includes one or more test steps of the plurality of test steps. A second subset of the one or more test steps are chained to one another by passing output data from a first test step of the second subset as input data to a second test step of the second subset. The output data of the first test step of the second subset is a third json object and the input data of the second test step of the second subset is a fourth json object. The chaining passes group and field level data from the third json object to the fourth json object. In a further aspect, the set of instructions are further configured to cause the processor to configure a feature including the first test scenario and the second test scenario, and chained the first test scenario to the second test scenario by passing output data from the first test scenario as input data to the second test scenario. The output data from the first test scenario includes output data from one or more test steps of the first subset. The input data to the second test scenario includes input data to one or more test steps of the second subset.

In a further aspect, the plurality of software services include one or more of batch services, application program interface services, and user interface services. In a still further aspect, the instructions configured to execute the first test scenario include further instructions configured to perform an end to-end test of the software system.

Another embodiment provides a non-transitory, computer-readable storage medium embodying computer program code for automating a test of the software system including a plurality of software services. The computer program code includes computer-executable instructions configured for defining a plurality of test steps where each test step includes one or more actions executed by a software service of the plurality of software services, configuring a first test scenario at an information handling system executing administrative console module of a test automation system, and executing the first test scenario at a test automation executor of the information handling system. The first test scenario includes one or more test steps of the plurality of test steps. A first subset of the one or more test steps are chained to one another by passing output data from a first test step of the first subset as input data to a second test step of the first subset. The output data of the first test step is a first json object. The input data of the second test step is a second json object. The chaining passes group and field level data from the first json object to the second json object.

In one aspect of the above embodiment, the computer program code includes further computer-executable instructions configured for collecting assertion information associated with each of the one or more steps of the first test scenario, and displaying a report including information associated with the assertion information. In another aspect of the above embodiment, the computer-executable instructions configured for configuring a first test scenario include further computer-executable instructions configured for selecting a test step of the plurality of test steps, determining input data for the test step where the input data includes one or more of user interface data, data output from a previous test step, and data provided from a data store, selecting output data from the test step for an assertion check, selecting a data source for comparison in the assertion check, and determining when an assertion check is performed.

In another aspect of the above embodiment, the computer program code includes further computer-executable instructions configured for configuring a second test scenario at the information handling system executing the administrative console module of the test automation system. A second test scenario includes one or more test steps of the plurality of test steps. A second subset of the one or more test steps are chained to one another by passing output data from a first test step of the second subset as input data to a second test step of the second subset. The output data of the first test step of the second subset is a first json object and the input data of the second test step of the second subset is a second json object. The chaining passes group and field level data from the first json object to the second json object.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of system 100 are circuitry located on a single integrated circuit or within a same device. Alternatively, system 100 may include any number of separate integrated circuits or separate devices interconnected with each other. For example, memory 112 may be located on a same integrated circuit as CPU 102 or on a separate integrated circuit or located within another peripheral or slave discretely separate from other elements of system 100. Subsystems 108 and I/O circuitry 104 may also be located on separate integrated circuits or devices. Also for example, system 100 or portions thereof may be soft or code representations of physical circuitry or of logical representations convertible into physical circuitry.

Furthermore, those skilled in the art will recognize that boundaries between the functionality of the above-described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

All or some of the software described herein may be received elements of system 100, for example, from computer readable media such as memory 112 or other media on other computer systems. Such computer readable media may be permanently, removably or remotely coupled to an information processing system such as system 100. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; M RAM; volatile storage media including registers, buffers or caches, main memory, RAM, etc.; and data transmission media including computer networks, point-to-point telecommunication equipment, and carrier wave transmission media, just to name a few.

In one embodiment, system 100 is a computer system such as a personal computer system. Other embodiments may include different types of computer systems. Computer systems are information handling systems which can be designed to give independent computing power to one or more users. Computer systems may be found in many forms including but not limited to mainframes, minicomputers, servers, workstations, personal computers, notepads, personal digital assistants, electronic games, automotive and other embedded systems, cell phones and various other wireless devices. A typical computer system includes at least one processing unit, associated memory and a number of input/output (I/O) devices.

A computer system processes information according to a program and produces resultant output information via I/O devices. A program is a list of instructions such as a particular application program and/or an operating system. A computer program is typically stored internally on computer readable storage medium or transmitted to the computer system via a computer readable transmission medium. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

1. A method for automating a test of a software system comprising a plurality of software services, the method comprising:
defining a plurality of test steps, wherein each test step comprises one or more actions executed by a software service of the plurality of software services;
configuring a first test scenario at an information handling system executing an administrative console module of a test automation system, wherein
the first test scenario comprises one or more test steps of the plurality of test steps, and
a first subset of the one or more test steps are chained to one another by passing output data from a first test step of the first subset as input data to a second test step of the first subset,
the output data of the first test step is a first JavaScript Object Notation (json) object,
wherein the second test step further receives as input data a second json object,
the chaining passes group and field level data from the first json object to the second json object;
executing the first test scenario at a test automation executor of the information handling system.

2. The method of claim 1 further comprising:
collecting assertion information associated with each of the one or more steps of the first test scenario;
displaying a report comprising information associated with the assertion information.

3. The method of claim 1 wherein said configuring the first test scenario comprises:
selecting a test step of the plurality of test steps;
determining input data for the test step, wherein said input data comprises one or more of user interface data, data output from a previous test step, and data provided from a data store;
selecting output data from the test step for an assertion check;
selecting a data source for comparison in the assertion check; and
determining when the assertion check is performed.

4. The method of claim 3 wherein said determining when the assertion check is performed comprises selecting whether the assertion check is performed prior to execution of the test step, subsequent to execution of the test step, or during execution of the test step.

5. The method of claim 1 further comprising:
configuring a second test scenario at the information handling system executing the administrative console module of the test automation system, wherein
the second test scenario comprises one or more test steps of the plurality of test steps, and
a second subset of the one or more test steps are chained to one another by passing output data from a first test step of the second subset as input data to a second test step of the second subset,
the output data of the first test step of the second subset is a third JavaScript Object Notation (json) object,
wherein the second test step further receives as input data a fourth json object,
the chaining passes group and field level data from the third json object to the fourth json object.

6. The method of claim 5 further comprising:
configuring a feature comprising the first test scenario and the second test scenario;
chaining the first test scenario to the second test scenario by passing output data from the first test scenario as input data to the second test scenario, wherein
the output data from the first test scenario comprises output data from one or more test steps of the first subset, and
the input data to the second test scenario comprises input data to one or more test steps of the second subset.

7. The method of claim 1 wherein the plurality of software services comprise one or more of batch services, application program interface (API) services, and user interface services.

8. The method of claim 7 wherein said executing the first test scenario comprises an end-to-end test of the software system.

9. An information handling system configured to automate a test of a software system comprising a plurality of software services, the information handling system comprising:
a processor configured to execute a set of instructions for automating the test of the software system;
a network interface, coupled to the processor and to a network, configured to communicate with one or more service provider servers coupled to the network, wherein each of the one or more service provider servers provides one or more corresponding software services of the plurality of software services; and
a non-transitory, computer-readable storage medium, coupled to the processor, and storing the set of instructions executable by the processor and configured to cause the processor to
define a plurality of test steps, wherein each test step comprises one or more actions executed by a software service of the plurality of software services,
configure a first test scenario, by an administrative console module of the test automation system, and
execute the first test scenario at a test automation executor of the information handling system, wherein
the first test scenario comprises one or more test steps of the plurality of test steps,
a first subset of the one or more test steps are chained to one another by passing output data from a first test step of the first subset as input data to a second test step of the first subset,
the output data of the first test step is a first JavaScript Object Notation (json) object,
the second test step further receives as input data a second json object, and
the chaining passes group and field level data from the first json object to the second json object.

10. The information handling system of claim 9 wherein the set of instructions are further configured to cause the processor to
collect assertion information associated with each of the one or more steps of the first test scenario;
display a report comprising information associated with the assertion information.

11. The information handling system of claim 9 wherein the instructions to configure the first test scenario comprise instructions further configured to cause the processor to
determine input data for the test step, wherein said input data comprises one or more of user interface data, data output from a previous test step, and data provided from a data store;
select output data from the test step for an assertion check;
select a data source for comparison in the assertion check; and
determine when the assertion check is performed.

12. The information handling system of claim 11 wherein the instructions to determine when the assertion check is performed comprise instructions further configured to cause the processor to select whether the assertion check is performed prior to execution of the test step, subsequent to execution of the test step, or during execution of the test step.

13. The information handling system of claim 9 wherein the set of instructions are further configured to cause the processor to
configure a second test scenario at the administrative console module of the test automation system, wherein
the second test scenario comprises one or more test steps of the plurality of test steps, and
a second subset of the one or more test steps are chained to one another by passing output data from a first test step of the second subset as input data to a second test step of the second subset,
the output data of the first test step of the second subset is a third JavaScript Object Notation (json) object,
the input data of wherein the second test step further receives as input data a fourth json object,
the chaining passes group and field level data from the third json object to the fourth json object.

14. The information handling system of claim 13 wherein the set of instructions are further configured to cause the processor to
configure a feature comprising the first test scenario and the second test scenario;
chain the first test scenario to the second test scenario by passing output data from the first test scenario to as input data to the second test scenario, wherein
the output data from the first test scenario comprises output data from one or more test steps of the first subset, and
the input data to the second test scenario comprises input data to one or more test steps of the second subset.

15. The information handling system of claim 9 wherein the plurality of software services comprise one or more of batch services, application program interface (API) services, and user interface services.

16. The information handling system of claim 15 wherein the instructions configured to execute the first test scenario comprise further instructions configured to perform an end-to-end test of the software system.

17. A non-transitory, computer-readable storage medium embodying computer program code for automating a test of a software system comprising a plurality of software services, the computer program code comprising computer-executable instructions configured for:
defining a plurality of test steps, wherein each test step comprises one or more actions executed by a software service of the plurality of software services;
configuring a first test scenario at an information handling system executing an administrative console module of a test automation system, wherein
the first test scenario comprises one or more test steps of the plurality of test steps, and
a first subset of the one or more test steps are chained to one another by passing output data from a first test step of the first subset as input data to a second test step of the first subset,
the output data of the first test step is a first JavaScript Object Notation (json) object,
wherein the second test step further receives as input data a second json object,
the chaining passes group and field level data from the first json object to the second json object;
executing the first test scenario at a test automation executor of the information handling system.

18. The non-transitory, computer-readable storage medium of claim 17, wherein the computer program code comprises further computer-executable instructions configured for:
collecting assertion information associated with each of the one or more steps of the first test scenario;
displaying a report comprising information associated with the assertion information.

19. The non-transitory, computer-readable storage medium of claim 17, wherein the computer-executable instructions configured for configuring a first test scenario comprises further computer-executable instructions configured for:
selecting a test step of the plurality of test steps;
determining input data for the test step, wherein said input data comprises one or more of user interface data, data output from a previous test step, and data provided from a data store;
selecting output data from the test step for an assertion check;
selecting a data source for comparison in the assertion check; and
determining when the assertion check is performed.

20. The non-transitory, computer-readable storage medium of claim 17, wherein the computer program code comprises further computer-executable instructions configured for:
configuring a second test scenario at the information handling system executing the administrative console module of the test automation system, wherein
the second test scenario comprises one or more test steps of the plurality of test steps, and
a second subset of the one or more test steps are chained to one another by passing output data from a first test step of the second subset as input data to a second test step of the second subset,
the output data of the first test step of the second subset is a third JavaScript Object Notation (json) object,
wherein the second test step further receives as input data a fourth json object,
wherein the second test step further receives a fourth json object,
the chaining passes group and field level data from the first json object to the second json object.
